(19) United States
(12) Patent Application Publication
(10) Pub. No.: US 2023/0275923 A1
(43) Pub. Date: Aug. 31, 2023

(54) Intelligent Detection of DDoS Attack Against IPsec On Cloud Native Framework

(71) Applicant: Parallel Wireless, Inc., Nashua, NH (US)

(72) Inventors: Ayan Chattopadhyay, Pune (IN); Vikram Menon, Pune (IN)

(21) Appl. No.: 18/158,467

(22) Filed: Jan. 23, 2023

Related U.S. Application Data
(60) Provisional application No. 63/301,623, filed on Jan. 21, 2022.

(51) Int. Cl. H04L 9/40

(52) U.S. Cl. CPC H04L 63/1458; H04L 63/164

(57) ABSTRACT

Systems and methods for detecting a Denial of Service (DoS) attack against Internet Protocol Security (IPsec) are disclosed. In one embodiment, a method comprises retrieving a first and a second Internet Security Association and Key Management Protocol (ISAKMP) packet, where the first ISAKMP packet and the second ISAKMP packet are received in immediate succession from a shared origin; storing a unique key out of a tuple wherein a value against the unique key is a time difference between the first and the second successive incoming packets; and calculating a score for each defined packet using a deep neural network, wherein a lower score value denotes an increased probability of having a DoS attack and a higher score value denotes a lower probability of a DoS attack.

### CROSS-REFERENCE TO RELATED APPLICATIONS

The present application is a non-provisional conversion of, and claims priority under 37 U.S.C. § 119(e) to, U.S. Provisional Pat. App. No. 63/301,623, filed Jan. 21, 2022, which is also hereby incorporated by reference. The present application also hereby incorporates by reference U.S. Pat. App. Pub. Nos. US20110044285, US20140241316; WO Pat. App. Pub. No. WO2013145592A1; EP Pat. App. Pub. No. EP2773151A1; U.S. Pat. No. 8,879,416, “Heterogeneous Mesh Network and Multi-RAT Node Used Therein,” filed May 8, 2013; U.S. Pat. No. 8,867,418, “Methods of Incorporating an Ad Hoc Cellular Network Into a Fixed Cellular Network,” filed Feb. 18, 2014; U.S. patent application Ser. No. 14/777,246, “Methods of Enabling Base Station Functionality in a User Equipment,” filed Sep. 15, 2016; U.S. patent application Ser. No. 14/289,821, “Method of Connecting Security Gateway to Mesh Network,” filed May 29, 2014; U.S. patent application Ser. No. 14/642,544, “Federated X2 Gateway,” filed Mar. 9, 2015; U.S. patent application Ser. No. 14/711,293, “Multi-Egress Backhaul,” filed May 13, 2015; U.S. Pat. App. No. 62/375,341, “S2 Proxy for Multi-Architecture Virtualization,” filed Aug. 15, 2016; U.S. patent application Ser. No. 15/132,229, “MaxMesh: Mesh Backhaul Routing,” filed Apr. 18, 2016, each in its entirety for all purposes, having attorney docket numbers PWS-71700US01, 71710US01, 71717US01, 71721US01, 71756US01, 71762US01, 71819US00, and 71820US01, respectively. This application also hereby incorporates by reference in their entirety each of the following U.S. Pat. applications or Pat. App. Publications: US20150098387A1 (PWS-71731US01); US20170055186A1 (PWS-71815US01); US20170273134A1 (PWS-71850US01); US20170272330A1 (PWS-71850US02); and Ser. No. 15/713,584 (PWS-71850US03). This application also hereby incorporates by reference in their entirety U.S. patent application Ser. No. 16/424,479, “5G Interoperability Architecture,” filed May 28, 2019; and U.S. Provisional Pat. Application No. 62/804,209, “5G Native Architecture,” filed Feb. 11, 2019.

### BACKGROUND

IPsec is currently the most preferred way of protecting sensitive information over network layer (L3). This plays one of the crucial roles in zero trust security model which today, the 5G era embraces. 5G is a distributed call model architecture and hence the volume of information exchange among different microservice components is large, effective protection of the information is expected. 5G assumes inherent cloud native framework for scale and performance, a clear DU (Data Unit, usually located at Radio Unit) and CU (Centralized Unit, mostly located at operator premises) split is the most preferred deployments. The zero trust security model assumes encrypted tunnel between DU and CU. Encrypted channel is secured against many different types of attack, most notably man in the middle attack. While this channel is usually not be compromised under suitable keys, this channel can be overwhelmed by the distributed denial of service (DDoS) attack and the network performance would be awfully poor.

### SUMMARY

Although there are many indigenous approaches to counter DDoS attack but none of them are considered full proof. In fact, it turns out that the best way to counter DDoS is to customize network architecture that specific to the deployment. Our approach is to make the deployment DDoS aware in an intelligent way. We have devised an architecture and methodology to protect IPsec tunnel endpoint (open ports 500/4500) by learning corresponding traffic pat-tern enough from the real world data or from the simulated data before actually being commissioned. Based on the acquired learning, the model will look for the upcoming IPsec traffic pattern from the network to figure out the chance of having DDoS attack against a specific packet stream.

To circumvent the above shortcomings and for better handling DDoS attack there could be a way to design custom plugin at the StrongSwan. The aim of the plugin is to detect DDoS attack more quickly and communicate with data-path about the attack and share the offending source/peer (IP/Port) for further action (block or blacklist). But such plugin would be having extra overhead. The plugin keeps itself busy in checking for every packet for any impending at-tack thereby increasing CPU utilization and memory footprint. In addition, the mitigation logic will also be based on static/pre-configured threshold values, the dynamic detection of DDoS attack can not be achieved. It is also to be noted that the plugin needs porting effort during every StrongSwan version upgrade.

Systems and methods for detecting a Denial of Service (DoS) attack against Internet Protocol Security (IPsec) are disclosed. In one embodiment, a method comprises retrieving a first and a second Internet Security Association and Key Management Protocol (ISAKMP) packet, where the first ISAKMP packet and the second ISAKMP packet are received in immediate succession from a shared origin; storing a unique key out of a tuple wherein a value against the unique key is a time difference between the first and the second successive incoming packets; calculating a score for each defined packet; when an arrival time difference is less than a previous arrival time difference, decreasing a score value; when an arrival time difference is the same as a previous arrival time difference, decreasing a score value; and when an arrival time difference is more than a previous arrival time difference, increasing a score value, wherein a lower score value denotes an increased probability of having a DoS attack and a higher score value denotes a lower probability of a DoS attack.

The method may be performed using a user space packet processing subsystem. The shared origin may be determined based on two or more of source IP, source port, and ISAKMP packet type. The method may further comprise calculating the score using a deep neural network. The method may further comprise calculating the score using a deep neural network having two hidden layers and an output layer with a sigmoid activation layer. The method may further comprise calculating the score using a deep neural network having three hidden layers and having a leaky rectified linear unit (ReLU) activation function. The method may further comprise using deep packet inspection to get a ISAKMP packet header. The method may further comprise providing a source IP, a source port, and an ISAKMP packet type to a deep neural network to calculate the score. wherein a time difference between a time of receipt of the first packet and a second time of receipt of the second packet may be provided to a deep neural network to calculate the score. The method may further comprise using a non-linear mathematical function to compute a modified score value.

### BRIEF DESCRIPTION OF THE DRAWINGS

FIG. 1 is a diagram showing a first deep neural network for DDoS detection, in accordance with some embodiments.

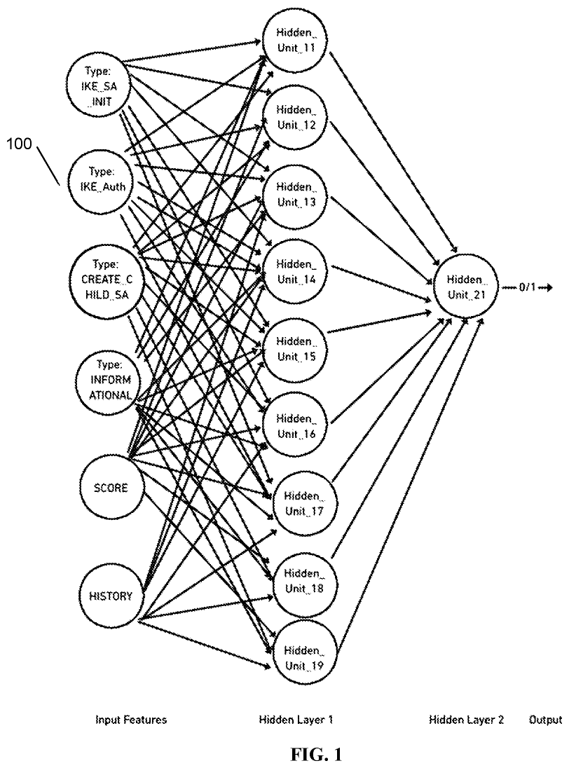

FIG. 2 is a diagram showing a second deep neural network for DDoS detection, in accordance with some embodiments.

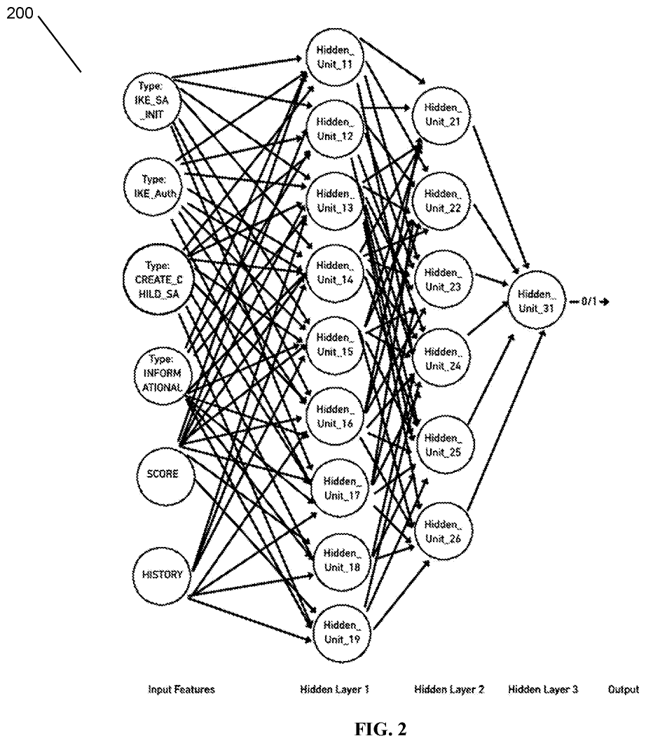

FIG. 3 is a schematic architecture diagram for a neural network providing DDoS detection, in accordance with some embodiments.

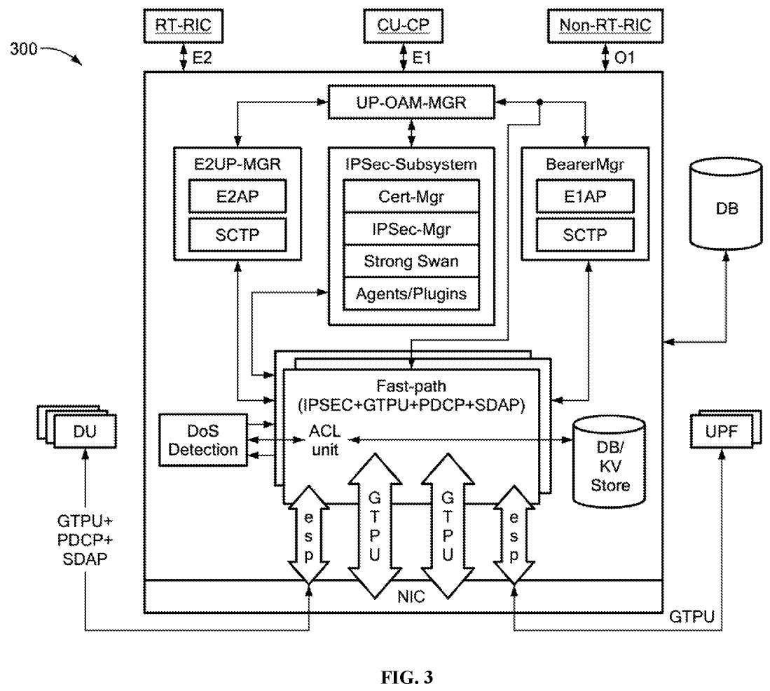

FIG. 4 is a logic diagram of score derivation for DDoS detection, in accordance with some embodiments.

FIG. 5 depicts a sample cost error output after training, in accordance with some embodiments.

FIG. 6 is a schematic network architecture diagram, in accordance with some embodiments. 5

FIG. 7 is an enhanced eNodeB for performing the methods described herein, in accordance with some embodiments.

FIG. 8 is a coordinating server for providing services and performing methods as described herein, in accordance with some embodiments.

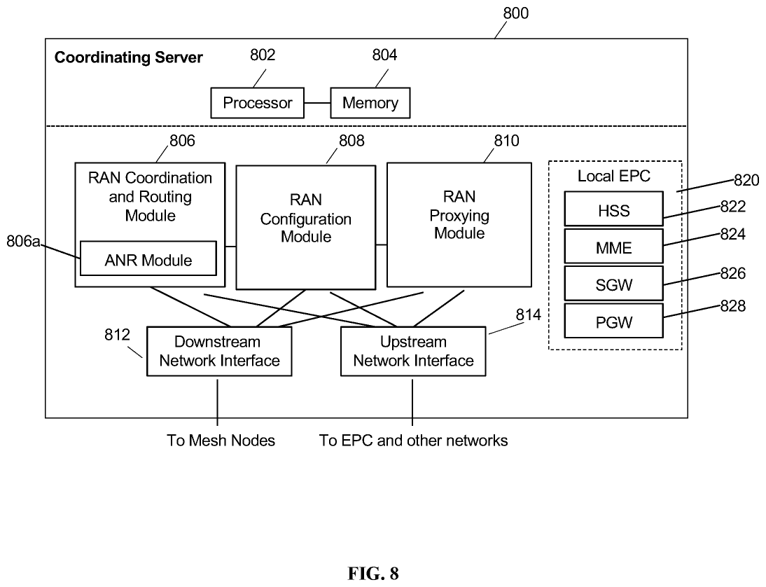

### DETAILED DESCRIPTION

IPsec is currently the most preferred way of protecting sensitive information over network layer (L3). This plays one of the crucial roles in zero trust security model which today, the 5G era embraces. 5G is a distributed call model architecture and hence the volume of information exchange among different microservice components is large, effective protection of the information is expected. 5G assumes inherent cloud native framework for scale and performance, a clear DU (Data Unit, usually located at Radio Unit) and CU (Centralized Unit, mostly located at operator premises) split is the most preferred deployments. The zero trust security model assumes encrypted tunnel between DU and CU. Encrypted channel is secured against many different types of attack, most notably man in the middle attack. While this channel is usually not be compromised under suit-able keys, this channel can be overwhelmed by the distributed denial of service (DDoS) attack and the network performance would be awfully poor.

StrongSwan, the open-source solution is widely used in industry for providing IKEv2 (IPsec control plane) and in PW (Parallel Wireless) architecture it is part of IPsec subsystem. Since StrongSwan takes all control plane packets (ISAKMP) at the network interface, it is the proper place to implement any DDoS detection mechanism. Vanilla StrongSwan has built-in DoS protection (e.g., half-open timeout, cookie verification) but that is neither sufficient nor a full proof mechanism against all types of attacks on IPsec channel. It is noted that the present application may be implemented using StrongSwan as well as another IPsec subsystem.

The built-in DDoS protection at StrongSwan is static in the sense that given the pre-configured threshold parameters (e.g block-threshold, cookie-threshold, half-open-timeout, ikesa-limit, init-limit-half-open, init-limit-job-load, etc). It decides the action (ACCEPT/DROP) to be taken on incoming packets. StrongSwan drops all the invalid packets, but doesn't have the logic to block or blacklist an offending peer. StrongSwan queues received packets given the worker thread model. The worker threads spend more time processing, hence incurring additional delay to detect possible attack.

In Kubernetes, a Pod (as in a pod of whales or pea pod) is a group of one or more containers, with shared storage and network resources, and a specification for how to run the containers. A Pod's contents may be co-located and co-scheduled, and run in a shared context. A Pod models an application-specific “logical host”: it contains one or more application containers which are relatively tightly coupled. In non-cloud contexts, applications executed on the same physical or virtual machine are analogous to cloud applications executed on the same logical host. Pods get their own IP and services get a cluster IP. Cluster IP is internal only. Kubernetes creates a cluster when a pod is created. Kubernetes supports a method for tracking which pods are available and/or down. It tracks which ones are live and which ones are down. While Kubernetes is described herein, other container management and orchestration methods are understood to be supported in the spirit of the present disclosure.

Pods are configured in Kubernetes using YAML files. A controller for the resource handles replication and rollout and automatic healing in case of Pod failure. For example, if a Node fails, a controller notices that Pods on that Node have stopped working and creates a replacement Pod. The scheduler places the replacement Pod onto a healthy Node.

In the present disclosure, a pod is a group of one or more containers, which may have shared storage and network resources, and which may also have a specification for how to run the containers. A pod's contents may be co-located and co-scheduled, and run in a shared context. A pod may be an application-specific logical host, or may be non-application specific. In some embodiments, applications may be executed on different or the same physical or virtual machine. In some embodiments, applications may be cloud applications executed on the same logical host, or executed at a different location. Where pods and/or containers are described herein, various alternatives are also considered, such as Linux containers, Kubernetes containers, Microsoft Azure, or other cloud-based software technologies.

Although there are many indigenous approaches to counter DDoS attack but none of them are considered full proof. In fact, it turns out that the best way to counter DDoS is to customize network architecture that specific to the deployment. Our approach is to make the deployment DDoS aware in intelligent way. We have devised an architecture and methodology to protect IPsec tunnel endpoint (open ports 500/4500) by learning corresponding traffic pat-tern enough from the real world data or from the simulated data before actually being commissioned. Based on the acquired learning, the model will look for the upcoming IPsec traffic pattern from the network to figure out the chance of having DDoS attack against a specific packet stream.

To circumvent the above shortcomings and for better handling DDoS attack there could be a way to design custom plugin at the StrongSwan. The aim of the plugin is to detect DDoS attack more quickly and communicate with data-path about the attack and share the offending source/peer (IP/Port) for further action (block or blacklist). But such plugin would be having extra overhead. The plugin keeps itself busy in checking for every packet for any impending at-tack thereby increasing CPU utilization and memory footprint. In addition, the mitigation logic will also be based on static/pre-configured threshold values, the dynamic detection of DDoS attack can not be achieved. It is also to be noted that the plugin needs porting effort during every StrongSwan version upgrade.

A possible approach, described in the next sections, is to have one DDoS detection component that takes input from both control plane (StrongSwan) and the data plane (IPsec/ESP) and output the binary verdict. This can be used to dynamically populate ACLs at the ingress/firewall to block offending peers and the dynamism can be achieved with an intelligent model based on AI/ML.

Data plane component is brought closer to NIC for the faster packet interception, processing and attack detection. The unit should be treated as a first line of defense against DoS attack and will reduce the load (CPU, Memory) on IPsec subsystem significantly. The unit or the underneath microservice component should be intelligent enough to look at the traffic pattern and decide the probability of any IPsec DDoS attack from a source (IP/Port) to report and act accordingly.

In some embodiments, a user space packet processing stack, such as DPDK or any other such stack, can be used (DPDK is used herein to mean any user space packet processing stack). DPDK is typically configured to receive every packet from network interface card (NIC) and it can be configured to use a rate limiter before further processing. In some embodiments this may be implemented on a DPDK cloud native pod/container. The DPDK can be configured to take every packet from NIC and apply metering, such that only slow-path packets (such as ISAKMP control packets) would be sent to DoS/DDoS detection microservice unit before sending the packet to the IPsec subsystem pod. (ISAKMP is a key establishment protocol defined by RFC 2408, which is hereby incorporated by reference for all purposes.)

Given, e.g., a ISAKMP packet pattern from a unique source, the task is to detect if packet/traffic pattern can be qualified to be a DoS attack. The output will be binary 0 or 1 where 1 indicates sign of detection of DoS attack.

This should be attributed to supervised learning model and we would like to propose deep neural network (DNN) as the learning model. We would be having two or three hidden layers with hidden units in each layer.

There are four types of ISAKMP packets, namely, IKE-SA-INIT (type 34), IKE-AUTH (type 35), CREATE-CHILD-SA (type 36), INFORMATIONAL (type 37) to be protected against DDoS attack. Although IKE-SA-INIT being used in non-encrypted channel is the most used type for the attack, but there is substantial probability of using other ISAKMP types for the attack. Every such packet type is to be an individual input feature, the value being 1 or 0 (packet type is selected or not).

The number of packet and rate would play a big role in determining DDoS detection. We have devised Score from the combination of packet rate and number of packet (derivation method to be discussed in the following architecture section), and this will be one input feature. It will also learn if this source IP port has any history of involving in DoS attack which will influence the decision if this can be marked as a probable DoS attack, so history will be another input feature. We could also think of any other feedback information (from metering unit or from any other run-time unit) as another input feature.

The following can be thought of the distinct input features: ISAKMP packet type 34 (1 or 0 based on selection/non-selection); ISAKMP packet type 35 (1 or 0 based on selection/non-selection); ISAKMP packet type 36 (1 or 0 based on selection/non-selection); ISAKMP packet type 37 (1 or 0 based on selection/non-selection); Score (strictly greater than 0, lower the score, higher the chance of attack); any previous history for the source IP-port, some sort of feedback (this info can be obtained from database). (Binary selection 1 or 0).

Since the input feature set is small, we could propose two models, one shallow and another deep in neural network depth.

Model-1 has two hidden layers (one inner and one output layer), in some embodiments. The inner hidden layer will be having hidden units approximately 1.5 times number of input features. The activation function is proposed to be used Leaky ReLU. The output layer is having one hidden unit and Sigmoid activation function is proposed to be used.

Model-2 has three hidden layers (two inner and one output layer), in some embodiments. The first hidden layer will be having hidden units approximately 1.5 times number of input features and the second hidden layer will be having hidden units same number of input features. The activation function used for the two inner hidden layers is proposed to be Leaky ReLU. The output layer is having one hidden unit and Sigmoid activation function is proposed to be used.

The predicted output will either be close to 0 or 1.

The following section shows the proposed DoS detection unit to be fit into the PW cloud native architecture and the interaction with other microservices or pods.

Score Derivation

Data-path pod/unit should do a deep packet inspection (DPI) to get the ISAKMP packet header to retrieve the type of ISAKMP packet which is one of the input features of the DoS detection unit. there will be a hash lookup or some form of dynamic array for storing the unique key out of tuple of source IP, source port, ISAKMP packet type (34-37) and the value against the unique key will be the time difference between two successive incoming similar packet. On each arrival of a defined packet a Score will be calculated. Initially ‘Score’ value will be set to 1. When the arrival packet time difference is less than the previous, then the Score value will be decreased non-linearly in smooth exponential slope (e.g. tanh or softsign). The ‘Score’ value will be approaching to 0 but it should stay always positive. The lower the ‘Score’ value, more the chance of having DoS attack.

When the packets are arriving in the same rate i.e. no change in present and previous time difference value, ‘Score’ will be lowered down slowly, decreasing the value with low constant term in every instant.

When the arrival packet time difference is more than the previous, ‘Score’ value will start increasing. A non-linear mathematical function will be used to compute the modified ‘Score’ value. The ‘Score’ will be approached to 1 or more and that would indicate very low probability of DoS attack. If arrival packet time difference is oscillating then ‘Score’ will also be oscillating and that will also indicate low probability of DoS attack. The packet rate would be initialized to a very high value.

Data-path pod/unit should do a deep packet inspection (DPI) to get the ISAKMP packet header to retrieve the type of ISAKMP packet which is one of the input features of the DoS detection unit.

There will be a hash lookup or some form of dynamic array for storing the unique key out of tuple of source IP, source port, ISAKMP packet type (34-37) and the value against the unique key will be the time difference between two successive incoming similar packet. On each arrival of a defined packet a Score will be calculated.

Initially ‘Score’ value will be set to 1.

When the arrival packet time difference is less than the previous, then the Score value will be decreased non-linearly in smooth exponential slope (e.g. tanh or softsign). The ‘Score’ value will be approaching to 0 but it should stay always positive. The lower the ‘Score’ value, more the chance of having DoS attack.

When the packets are arriving in the same rate i.e. no change in present and previous time difference value, ‘Score’ will be lowered down slowly, decreasing the value with low constant term in every instant.

When the arrival packet time difference is more than the previous, ‘Score’ value will start increasing. A non-linear mathematical function will be used to compute the modified ‘Score’ value. The ‘Score’ will be approached to 1 or more and that would indicate very low probability of DoS attack.

If arrival packet time difference is oscillating then ‘Score’ will also be oscillating and that will also indicate low probability of DoS attack.

The packet rate would be initialized to a very high value.

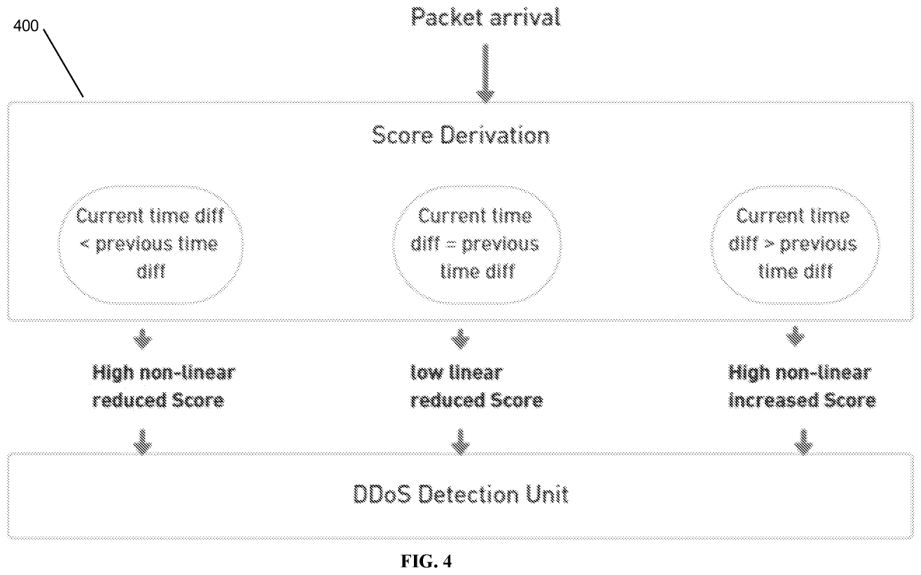

FIG. 4 is a schematic representation of a logic behind ‘Score derivation,’ in accordance with some embodiments.

Interaction with Other Units

Persistent cache or Database is always consulted by data plane unit be-fore processing to check any prior DoS history of the source (IP/port) combination, the info will be one of the inputs to the DoS detection unit.

DoS detection unit could be a separate pod/container or could be one monolithic module inside data plane/data-path. The first option is pre-ferred although the choice would be the design decision and the trade of between ease of implementation and the optimum performance.

If it would be a separate pod, this would communicate with ACL unit of the data-path pod. If detected DoS, this will give feedback to data-path

ACL unit to put the source IP/port to blacklist array and the database will also be updated to modify history for the source (IP/port).

DoS detection unit would be having one utility of periodic survey in the persistent cache of having any new source entry from which the DoS attack was mediated. The deep neural network model will be periodically run to refine parameters for all hidden units inside hidden layers in order to improve the better and effective attack detection mechanism.

In order to train the model, We collect moderate number of samples either from the field or by running simulation or by performing experiments. The collected samples will be parsed and ‘Score’ value will be calculated from each sample. This, along with the corresponding collected sample will be put to comma sep-arated value (CSV) formatted file and the model will read this in order to get input features. After training the DNN model with the sufficient training sam-ples, the model can be tested against fresh set of samples (test sample) to see the model can detect DDoS attack efficiently. The output will be the chance in percentage of detecting DDoS attack.

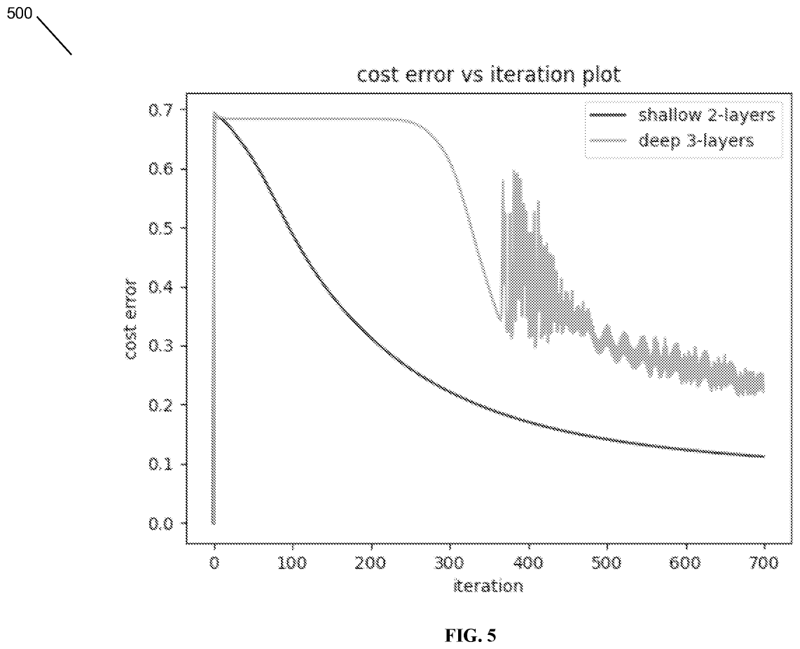

FIG. 5 is one sample cost error output after training both the models.

The cost error output from the deep model is too noisy, this clearly indicates that the best model to select is the shallow model (model is having one hidden and one output layer). The performance of the ‘deep’ model is poor probably because the input feature set is small.

One can devise a model which could look into the traffic pattern and shaping on the fly, adaptive in unsupervised way to learn the probability of DoS attack. But with this approach the chance of initial failure would be high and might defeat the purpose of effective protection of the network. DDoS attack on IPsec is not very frequent event in networking world, but when it would occur, the system is expected to catch and act early to avoid any catastrophe. Our AI capable detection model is best suited against this expectation and requirement.

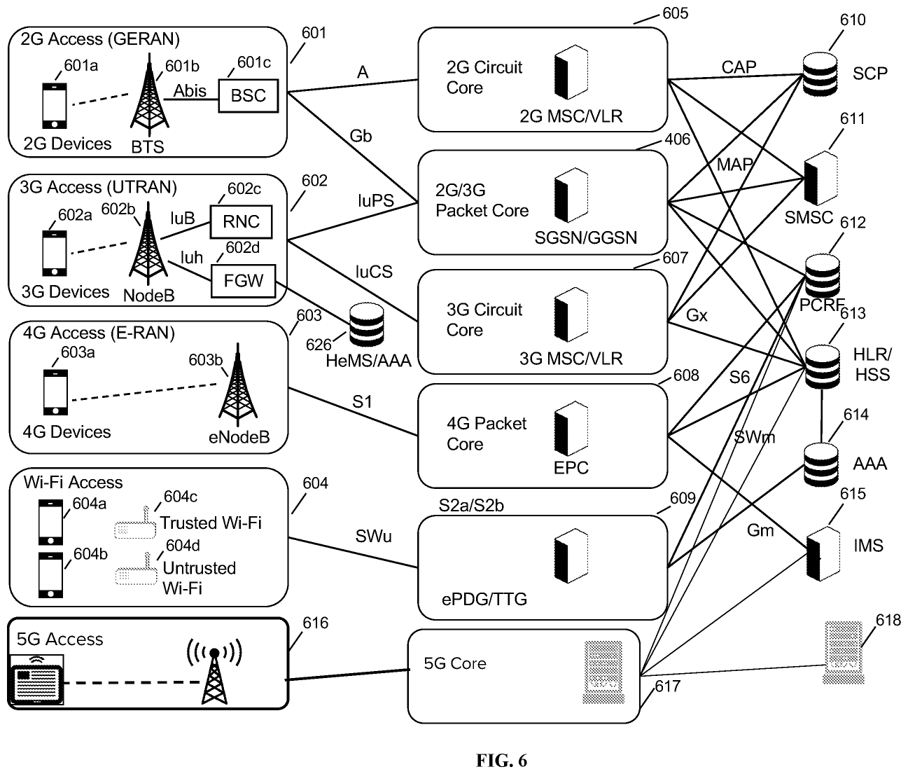

FIG. 6 is a schematic network architecture diagram for telecom networks. The diagram shows a plurality of “Gs,” including 2G, 3G, 4G, 5G and Wi-Fi. 2G is represented by GERAN 601, which includes a 2G device 601a, BTS 601b, and BSC 601c. 3G is represented by UTRAN 602, which includes a 3G UE 602a, nodeB 602b, RNC 602c, and femto gateway (FGW, which in 3GPP namespace is also known as a Home nodeB Gateway or HNBGW) 602d. 4G is represented by EUTRAN or E-RAN 603, which includes an LTE UE 603a and LTE eNodeB 603b. Wi-Fi is represented by Wi-Fi access network 604, which includes a trusted Wi-Fi access point 604c and an untrusted Wi-Fi access point 604d. The Wi-Fi devices 604a and 604b may access either AP 604c or 604d. In the current network architecture, each “G” has a core network. 2G circuit core network 605 includes a 2G MSC/VLR; 2G/3G packet core network 606 includes an SGSN/GGSN (for EDGE or UMTS packet traffic); 3G circuit core 607 includes a 3G MSC/VLR; 4G circuit core 608 includes an evolved packet core (EPC); and in some embodiments the Wi-Fi access network may be connected via an ePDG/TTG using S2a/S2b. Each of these nodes are connected via a number of different protocols and interfaces, as shown, to other, non-“G”-specific network nodes, such as the SCP 630, the SMSC 631, PCRF 632, HLR/HSS 633, Authentication, Authorization, and Accounting server (AAA) 634, and IP Multimedia Subsystem (IMS) 635. An HeMS/AAA 636 is present in some cases for use by the 3G UTRAN. The diagram is used to indicate schematically the basic functions of each network as known to one of skill in the art, and is not intended to be exhaustive. For example, 5G core 617 is shown using a single interface to 5G access 616, although in some cases 5G access can be supported using dual connectivity or via a non-standalone deployment architecture.

Noteworthy is that the RANs 601, 602, 603, 604 and 636 rely on specialized core networks 605, 606, 607, 608, 609, 637 but share essential management databases 630, 631, 632, 633, 634, 635, 638. More specifically, for the 2G GERAN, a BSC 601c is required for Abis compatibility with BTS 601b, while for the 3G UTRAN, an RNC 602c is required for Iub compatibility and an FGW 602d is required for Iuh compatibility. These core network functions are separate because each RAT uses different methods and techniques. On the right side of the diagram are disparate functions that are shared by each of the separate RAT core networks. These shared functions include, e.g., PCRF policy functions, AAA authentication functions, and the like. Letters on the lines indicate well-defined interfaces and protocols for communication between the identified nodes.

DDoS detection is enabled using deep packet inspection (DPI), as described above. It is suitable to provide this functionality in any of the RAT cores, with special attention to the 5G core 617 and 4G core 608, but also possible to be enabled in any core or any other network node, including RAN nodes that have greater compute capacity, or including nodes that are located between the RAN and the core, for example RNC 602c or another node with a similar topology. In addition, a machine learning model could be trained offline and transferred to a core node to be executed there. In some embodiments, the ML models may be executed using container orchestration technologies such as Kubernetes. In some embodiments, a container orchestrator may orchestrate DDoS detection across multiple RATs.

The system may include 5G equipment. 5G networks are digital cellular networks, in which the service area covered by providers is divided into a collection of small geographical areas called cells. Analog signals representing sounds and images are digitized in the phone, converted by an analog to digital converter and transmitted as a stream of bits. All the 5G wireless devices in a cell communicate by radio waves with a local antenna array and low power automated transceiver (transmitter and receiver) in the cell, over frequency channels assigned by the transceiver from a common pool of frequencies, which are reused in geographically separated cells. The local antennas are connected with the telephone network and the Internet by a high bandwidth optical fiber or wireless backhaul connection.

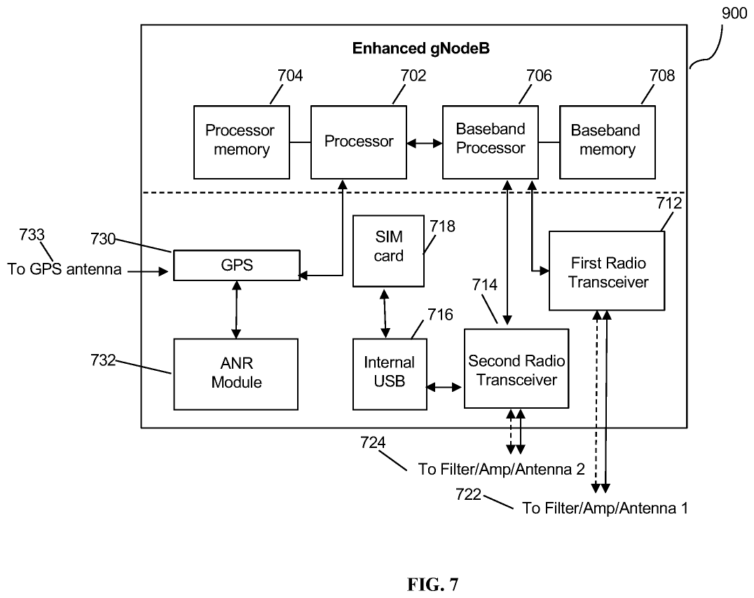

FIG. 7 is an enhanced eNodeB for performing the methods described herein, in accordance with some embodiments. eNodeB 700 may include processor 702, processor memory 704 in communication with the processor, baseband processor 706, and baseband processor memory 708 in communication with the baseband processor. Mesh network node 700 may also include first radio transceiver 712 and second radio transceiver 714, internal universal serial bus (USB) port 716, and subscriber information module card (SIM card) 718 coupled to USB port 716. In some embodiments, the second radio transceiver 714 itself may be coupled to USB port 716, and communications from the baseband processor may be passed through USB port 716. The second radio transceiver may be used for wirelessly backhauling eNodeB 700.

Processor 702 and baseband processor 706 are in communication with one another. Processor 702 may perform routing functions, and may determine if/when a switch in network configuration is needed. Baseband processor 706 may generate and receive radio signals for both radio transceivers 712 and 714, based on instructions from processor 702. In some embodiments, processors 702 and 706 may be on the same physical logic board. In other embodiments, they may be on separate logic boards.

Processor 702 may identify the appropriate network configuration, and may perform routing of packets from one network interface to another accordingly. Processor 702 may use memory 704, in particular to store a routing table to be used for routing packets. Baseband processor 706 may perform operations to generate the radio frequency signals for transmission or retransmission by both transceivers 710 and 712. Baseband processor 706 may also perform operations to decode signals received by transceivers 712 and 714. Baseband processor 706 may use memory 708 to perform these tasks.

The first radio transceiver 712 may be a radio transceiver capable of providing LTE eNodeB functionality, and may be capable of higher power and multi-channel OFDMA. The second radio transceiver 714 may be a radio transceiver capable of providing LTE UE functionality. Both transceivers 712 and 714 may be capable of receiving and transmitting on one or more LTE bands. In some embodiments, either or both of transceivers 712 and 714 may be capable of providing both LTE eNodeB and LTE UE functionality. Transceiver 712 may be coupled to processor 702 via a Peripheral Component Interconnect-Express (PCI-E) bus, and/or via a daughtercard. As transceiver 714 is for providing LTE UE functionality, in effect emulating a user equipment, it may be connected via the same or different PCI-E bus, or by a USB bus, and may also be coupled to SIM card 718. First transceiver 712 may be coupled to first radio frequency (RF) chain (filter, amplifier, antenna) 722, and second transceiver 714 may be coupled to second RF chain (filter, amplifier, antenna) 724.

SIM card 718 may provide information required for authenticating the simulated UE to the evolved packet core (EPC). When no access to an operator EPC is available, a local EPC may be used, or another local EPC on the network may be used. This information may be stored within the SIM card, and may include one or more of an international mobile equipment identity (IMEI), international mobile subscriber identity (IMSI), or other parameter needed to identify a UE. Special parameters may also be stored in the SIM card or provided by the processor during processing to identify to a target eNodeB that device 700 is not an ordinary UE but instead is a special UE for providing backhaul to device 700.

Wired backhaul or wireless backhaul may be used. Wired backhaul may be an Ethernet-based backhaul (including Gigabit Ethernet), or a fiber-optic backhaul connection, or a cable-based backhaul connection, in some embodiments. Additionally, wireless backhaul may be provided in addition to wireless transceivers 712 and 714, which may be Wi-Fi 802.11a/b/g/n/ac/ad/ah, Bluetooth, ZigBee, microwave (including line-of-sight microwave), or another wireless backhaul connection. Any of the wired and wireless connections described herein may be used flexibly for either access (providing a network connection to UEs) or backhaul (providing a mesh link or providing a link to a gateway or core network), according to identified network conditions and needs, and may be under the control of processor 702 for reconfiguration.

A GPS module 730 may also be included, and may be in communication with a GPS antenna 732 for providing GPS coordinates, as described herein. When mounted in a vehicle, the GPS antenna may be located on the exterior of the vehicle pointing upward, for receiving signals from overhead without being blocked by the bulk of the vehicle or the skin of the vehicle. Automatic neighbor relations (ANR) module 732 may also be present and may run on processor 702 or on another processor, or may be located within another device, according to the methods and procedures described herein.

Other elements and/or modules may also be included, such as a home eNodeB, a local gateway (LGW), a self-organizing network (SON) module, or another module. Additional radio amplifiers, radio transceivers and/or wired network connections may also be included.

Coordinating server 800 includes processor 802 and memory 804, which are configured to provide the functions described herein. Also present are radio access network coordination/routing (RAN Coordination and routing) module 808, including ANR module 808a, RAN configuration module 808, and RAN proxying module 810. The ANR module 808a may perform the ANR tracking, PCI disambiguation, ECGI requesting, and GPS coalescing and tracking as described herein, in coordination with RAN coordination module 808 (e.g., for requesting ECGIs, etc.). In some embodiments, coordinating server 800 may coordinate multiple RANs using coordination module 808. In some embodiments, coordination server may also provide proxying, routing virtualization and RAN virtualization, via modules 810 and 808. In some embodiments, a downstream network interface 812 is provided for interfacing with the RANs, which may be a radio interface (e.g., LTE), and an upstream network interface 814 is provided for interfacing with the core network, which may be either a radio interface (e.g., LTE) or a wired interface (e.g., Ethernet).

Coordinator 800 includes local evolved packet core (EPC) module 820, for authenticating users, storing and caching priority profile information, and performing other EPC-dependent functions when no backhaul link is available. Local EPC 820 may include local HSS 822, local MME 824, local SGW 828, and local PGW 828, as well as other modules. Local EPC 820 may incorporate these modules as software modules, processes, or containers. Local EPC 820 may alternatively incorporate these modules as a small number of monolithic software processes. Modules 808, 808, 810 and local EPC 820 may each run on processor 802 or on another processor, or may be located within another device.

In any of the scenarios described herein, where processing may be performed at the cell, the processing may also be performed in coordination with a cloud coordination server. A mesh node may be an eNodeB. An eNodeB may be in communication with the cloud coordination server via an X2 protocol connection, or another connection. The eNodeB may perform inter-cell coordination via the cloud communication server, when other cells are in communication with the cloud coordination server. The eNodeB may communicate with the cloud coordination server to determine whether the UE has the ability to support a handover to Wi-Fi, e.g., in a heterogeneous network.

Although the methods above are described as separate embodiments, one of skill in the art would understand that it would be possible and desirable to combine several of the above methods into a single embodiment, or to combine disparate methods into a single embodiment. For example, all of the above methods could be combined. In the scenarios where multiple embodiments are described, the methods could be combined in sequential order, or in various orders as necessary.

Although the above systems and methods for providing interference mitigation are described in reference to 3GPP 5G standard, one of skill in the art would understand that these systems and methods could be adapted for use with other wireless standards or versions thereof. The inventors have understood and appreciated that the present disclosure could be used in conjunction with various network architectures and technologies. Wherever a 5G technology is described, the inventors have understood that other RATs have similar equivalents, such as LTE. Wherever an 5G AMF/SMF is described, the 5G AMF/SMF could be a 3G RNC or a MME. Additionally, wherever an 5G AMF/SMF is described, any other node in the core network could be managed in much the same way or in an equivalent or analogous way, for example, multiple connections to 5G AMF/SMF, or any other node for any other RAT, could be periodically evaluated for health and otherwise monitored, and the other aspects of the present disclosure could be made to apply, in a way that would be understood by one having skill in the art.

In some embodiments, the base stations described herein may support Wi-Fi air interfaces, which may include one or more of IEEE 802.11a/b/g/n/ac/af/p/h. In some embodiments, the base stations described herein may support IEEE 802.16 (WiMAX), to LTE transmissions in unlicensed frequency bands (e.g., LTE-U, Licensed Access or LA-LTE), to LTE transmissions using dynamic spectrum access (DSA), to radio transceivers for ZigBee, Bluetooth, or other radio frequency protocols, or other air interfaces.

In some embodiments, the software needed for implementing the methods and procedures described herein may be implemented in a high level procedural or an object-oriented language such as C, C++, C #, Python, Java, or Perl. The software may also be implemented in assembly language if desired. Packet processing implemented in a network device can include any processing determined by the context. For example, packet processing may involve high-level data link control (HDLC) framing, header compression, and/or encryption. In some embodiments, software that, when executed, causes a device to perform the methods described herein may be stored on a computer-readable medium such as read-only memory (ROM), programmable-read-only memory (PROM), electrically erasable programmable-read-only memory (EEPROM), flash memory, or a magnetic disk that is readable by a general or special purpose-processing unit to perform the processes described in this document. The processors can include any microprocessor (single or multiple core), system on chip (SoC), microcontroller, digital signal processor (DSP), graphics processing unit (GPU), or any other integrated circuit capable of processing instructions such as an x86 microprocessor.

The foregoing discussion discloses and describes merely exemplary embodiments of the present invention. In some embodiments, software that, when executed, causes a device to perform the methods described herein may be stored on a computer-readable medium such as a computer memory storage device, a hard disk, a flash drive, an optical disc, or the like. As will be understood by those skilled in the art, the present invention may be embodied in other specific forms without departing from the spirit or essential characteristics thereof. For example, wireless network topology can also apply to wired networks, optical networks, and the like. The methods may apply to LTE-compatible networks, to UMTS-compatible networks, or to networks for additional protocols that utilize radio frequency data transmission. Various components in the devices described herein may be added, removed, split across different devices, combined onto a single device, or substituted with those having the same or similar functionality.

Although the present disclosure has been described and illustrated in the foregoing example embodiments, it is understood that the present disclosure has been made only by way of example, and that numerous changes in the details of implementation of the disclosure may be made without departing from the spirit and scope of the disclosure, which is limited only by the claims which follow. Various components in the devices described herein may be added, removed, or substituted with those having the same or similar functionality. Various steps as described in the figures and specification may be added or removed from the processes described herein, and the steps described may be performed in an alternative order, consistent with the spirit of the invention. Features of one embodiment may be used in another embodiment.

1. A method of detecting a Denial of Service (DoS) attack against Internet Protocol Security (IPsec) on a cloud native framework, the method comprising:
retrieving a first and a second Internet Security Association and Key Management Protocol (ISAKMP) packet, where the first ISAKMP packet and the second ISAKMP packet are received in immediate succession from a shared origin;
storing a unique key out of a tuple wherein a value against the unique key is a time difference between the first and the second successive incoming packets;
calculating a score for each defined packet;
when an arrival time difference is less than a previous arrival time difference, decreasing a score value;
when an arrival time difference is the same as a previous arrival time difference, decreasing a score value; and
when an arrival time difference is more than a previous arrival time difference, increasing a score value,
wherein a lower score value denotes an increased probability of having a DoS attack and a higher score value denotes a lower probability of a DoS attack.

2. The method of claim 1, wherein the method is performed using a user space packet processing subsystem.

3. The method of claim 1, wherein the shared origin is determined based on two or more of source IP, source port, and ISAKMP packet type.

4. The method of claim 1, further comprising calculating the score using a deep neural network.

5. The method of claim 1, further comprising calculating the score using a deep neural network having two hidden layers and an output layer with a sigmoid activation layer.

6. The method of claim 1, further comprising calculating the score using a deep neural network having three hidden layers and having a leaky rectified linear unit (ReLU) activation function.

7. The method of claim 1, further comprising using deep packet inspection to get a ISAKMP packet header.

8. The method of claim 1, further comprising providing a source IP, a source port, and an ISAKMP packet type to a deep neural network to calculate the score.

9. The method of claim 1, wherein a time difference between a time of receipt of the first packet and a second time of receipt of the second packet is provided to a deep neural network to calculate the score.

10. The method of claim 1, further comprising using a non-linear mathematical function to compute a modified score value.
